(19) United States
(12) Patent Application Publication
(10) Pub. No.: US 2008/0252938 A1
(43) Pub. Date: Oct. 16, 2008

(54) COMBINING AN ORIGINAL IMAGE AND A MODIFIED IMAGE INTO A SINGLE IMAGE FILE

(76) Inventors: Robert P. Cazier, Fort Collins, CO (US); Murray Dean Craig, Johnstown, CO (US); Michelle Ogg, Loveland, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/734,055

(22) Filed: Apr. 11, 2007

(51) Int. Cl. H04N 1/387

(52) U.S. Cl. 358/450; 382/276

(57) ABSTRACT

A method is provided for storing an original image and a modified image into a single image file. The method comprises selecting the original image, selecting the modified image. The method further comprises creating a single image by combining the original image with the modified image. The method further comprises storing the single image into a single image file on a memory device.

### BACKGROUND

Digital manipulation of images is becoming more commonplace. A user may load an image file containing an original image and modify the image. The user may save the modified image in a different file than the file containing the original image. A modified image file is defined as an image file containing original image data that has been changed, reduced, augmented, or otherwise manipulated. The user may display, copy, move, rename, send or print the modified image. Some programs allow a user to load the original image file and the modified image file, and then display or print the images side-by-side. This allows a user to show a copy of the image before and after the modification. Unfortunately, these programs don't save the two images into a single image file; they keep the two images in the two original files, the original image file and the modified image file.

At some future date, the user may wish to access the original or source image of the modified image. Finding the original source image for a modified image may be difficult. The name of the original image file may not be related to the name of the modified image file. The original and modified image files may not be in the same sub-directory, or on the same memory device. Some programs may link the two files using a history of editing commands or storing information in the metadata of the modified image file. Unfortunately, these links can be broken if one or both of the files are moved, renamed or otherwise changed.

### BRIEF DESCRIPTION OF THE DRAWINGS

FIG. 1. is a flow chart showing the steps used to combine an original image and a modified image into a single image file in an example embodiment of the invention.

FIG. 2A-2E. are diagrams showing the orientation between an original image and a modified image in some example embodiments of the invention.

### DETAILED DESCRIPTION

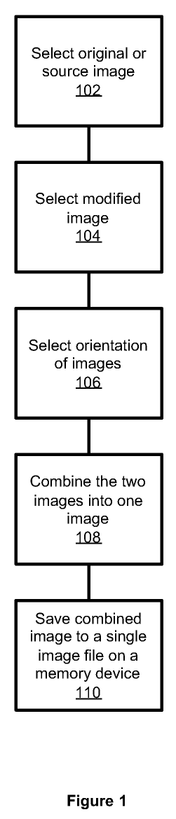

FIG. 1 and the following description depict specific examples to teach those skilled in the art how to make and use the best mode of the invention. For the purpose of teaching inventive principles, some conventional aspects have been simplified or omitted. Those skilled in the art will appreciate variations from these examples that fall within the scope of the invention. Those skilled in the art will appreciate that the features described below can be combined in various ways to form multiple variations of the invention. As a result, the invention is not limited to the specific examples described below, but only by the claims and their equivalents.

FIG. 1 is a flow chart showing the steps used to combine an original or source image and a modified image into a single image file in an example embodiment of the invention. At step 102, the original or source image file is selected. At step 104, the modified image file is selected. A modified image file is defined as an image file containing original image data that has been changed, reduced, augmented, or otherwise manipulated. At optional step 106, the orientation between the two images is selected, for example side-by-side or one above the other. At step 108, the two images are combined into a single image (described below). At step 110, the combined image is saved to a memory device as a single image file.

At steps 102 and 104, the image files may be selected using any number of user interface methods, for example a text box, a drag-and-drop metaphor, a clickable version of the image, or the like. The order in which the image files are selected is unimportant; the original or source image may be selected first or last.

In one example embodiment of the invention, the selection of the files may be automated. As an example, an editing program may save a modified image file using a naming schema that indicates the relationship between the original file and the modified file. Once one of the images files is selected, the other related image files can be found and selected automatically using the naming schema. The automated selection process may use other information that identifies the related files, for example meta-data. A user may select the automatic selection method using any user interface device, for example a tool labeled “combine all related images”.

Image files are created in a number of different formats, including, for example, Portable Document Format (PDF), Tagged Image File Format (TIFF or TIF), a binary image format (BIN), Windows Bitmap (BMP), Joint Photographic Experts Group (JPEG or JPG), or the like. Each type of image file may have a number of different data fields and may use a different order for storing the data, but most image file types have a number of common fields. Typically, each type of image file contains at least the width and height of the image, the image data type (for example, 24-bit color or 8-bit grayscale), the resolution of the image and the image data. The image data may be stored as one or more rows of pixels, where each pixel is a 24-bit value that represents the colors of that pixel (for example, the red, green and blue values of the pixel). In another implementation, the image data may be stored as color planes, with the red data for all of the pixels stored in a first plane, the green pixel data stored in a second plane, and the blue pixel data stored in a third plane.

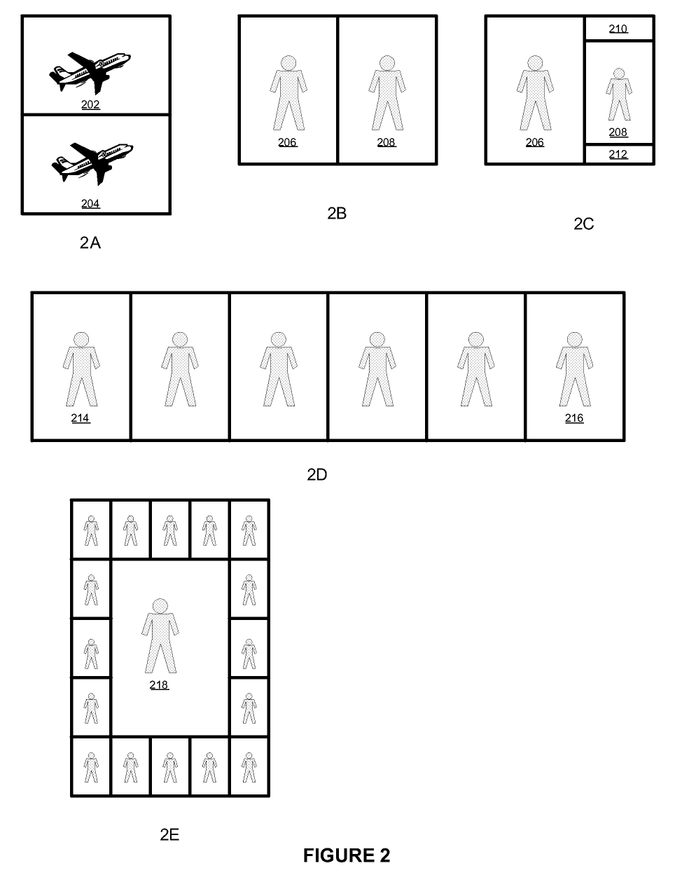

At step 106, the image orientation is selected. In one example embodiment of the invention, the orientation between the two images defaults to a predefined orientation, such as side-by-side (See FIG. 2B). When the user wishes to change from the default orientation, the user may change the program flow by selecting an orientation option or tool. In another example embodiment of the invention, the user is automatically prompted for the orientation of the images. In another example embodiment of the invention, the orientation of the images may be determined using an algorithm. For example, images that have a height greater than its width may be oriented side-by-side automatically.

Once the orientation between the two images has been determined, the image data is loaded into memory from the two image files, and the images are shown on the display screen. In another example embodiment of the invention, the orientation between the images may be adjusted after the images are displayed, such as by way of a drag-and-drop metaphor.

Memory is defined as the memory allocated or controlled by the program or tool that is implementing an embodiment of the current invention. In one example embodiment, the image data loaded into memory from the two image files is held in memory using an internal data format. In one implementation, the internal data format may be optimized to facilitate display or manipulation of the image. In another example embodiment of the current invention, the image data is held in memory using a standard image format, such as JPEG or any other format described herein.

Many image file formats require the stored image to be rectangular or square in shape. Some image file types may allow non-rectangular shapes to be stored. The file formats that allow non-rectangular shapes are typically more complex than other image file formats. In one example embodiment of the invention, the image shape for the combined image may be required to have a rectangular or square shape. In another example embodiment of the invention, the combined image may be allowed to be non-rectangular in shape.

When combining two images of different sizes, one or both of the images may be modified to create a final image having a rectangular shape. An image can be resized by resealing, padding, cropping or the like. In one example embodiment of the invention, if one image is a different size than the other image, one of the images may be resealed such that the heights or widths of the two images are the same. Resizing images is well-known in the arts. FIG. 2A-2E. are diagrams showing the orientation between an original image and a modified image in some example embodiments of the invention. In another example embodiment of the invention, a filler (210 and 212) may be used to pad the smaller image (208) such that the height or width of the smaller image (208) matches the height or width of the larger image (206). In various examples, the filler may be any shade or color, or may be transparent. When the image orientation is side-by-side (2B and 2C), the heights of the two images may be matched, and when the orientation is one above the other (2A), the image widths may be matched. The larger image may also be cropped to match the smaller image size.

Once the two images are the same size, either through resealing, padding or cropping, the images can be combined into a single square or rectangular image. The complexity of combining the two images into a single image may depend on how the two images are currently stored in memory. If both images are already stored in memory using a common format, for example an internal format, creating a single image may be as simple as calculating a new height and width for the total image and then combining the image data into a common memory location. To combine the image data into a common location the top row of the first image is read from its current location and written to the new location, the top row of the second image is read from its current location and written to the new location immediately after the first row from the first image. This is continued until all the rows from both images have been written into the new location. This assumes that the image data is stored in memory by rows. Other orders for combining the image data would be used for other data formats.

If the two images are currently stored in memory with different formats, combining the images may first require translating the two images into a common format. This translation may involve realigning image data from three color planes into equivalent pixel data, translating color data into grayscale data, or the like. Once both images are in a common data format, the images can be combined into a single image. When combining unequally sized images into a single non-rectangular image, the smaller image may be centered with respect to the larger image, or aligned with an edge of the larger image.

When saving the combined image at step 110, an image type needs to be selected. In one example embodiment of the invention, if the original image and the modified image have the same file type, the combined image may automatically be saved using the common image file type. If the two images are stored using different file types, the user may be prompted to select a file type for the combined file, or a default file type may be used, for example the file type of the modified image. In another example embodiment of the invention, the user may choose the file type for the combined image file.

The allowable image shape of the combined image may be determined by the type of image file used to store the combined image. In one example embodiment of the invention, the file type for the combined image may be determined before the two images are combined. In another example embodiment of the invention, the file types available for storing the combined image may be restricted depending on the shape of the combined image. For example, when the combined image is square or rectangular in shape, all the file types will be available and when the combined image is not square or rectangular, only those file types that can store a non-rectangular image will be available.

Steps 108 and 110 may be combined into a single operation. In this case, the individual image data from the two images may be combined as the data is stored onto the memory device as a single image file. A memory device is any non-volatile device that can hold data and includes, for example, magnetic disk storage, optical disk storage (such as DVDs), memory sticks, molecular storage, and the like.

In another example embodiment of the invention, multiple modified images may be combined with an original image and saved into a single image file. Some users may make multiple changes to an image and save a copy of the image after each step in the modification process. A composite image with the fully modified image (214) in the center and the progressively modified images arranged around the edge of the fully modified image may be desired (See FIG. 2E). Other layouts, such as an arrangement that shows a linear progression of modified images (See FIG. 2D) beginning with the original image (214) and ending with the fully modified image (216), are foreseen. Another possible layout is two-dimensional array of images, wherein the original image is located at the top-left, and each successive modified image follows along each of the rows of the array left-to-right, ending at the bottom-right corner of the image array.

When combining multiple images into a single image, all the images do not need to be the same size to create a combined image having a rectangular or square shape. One image, for example the fully modified image 218, may be larger with smaller images wrapped around the perimeter of the larger image (see FIG. 2E).

In one example embodiment of the invention, a standalone software program may be used to combine the original image file and the modified image file into a single image file. In another example embodiment of the invention, combining the original image file and the modified image file into a single image file may be done as one of many optional functions or tools of a larger software or firmware program, such as an image editing software program. A user may activate the combinational function using a user interface device, for example an icon or a menu item. The software or firmware used to implement this invention may run on any type of computer, microprocessor, or processor system, for example inside a digital camera.

What is claimed is:

1. A method for storing an original image and a modified image into a single image file, the method comprising:
selecting the original image;
selecting the modified image;
combining the original image with the modified image into a single image; and
storing the single image into a single image file on a memory device.

2. The method of claim 1, further comprising:
selecting the orientation between the original image and the modified image.

3. The method of claim 2, wherein the orientation can be selected from the group: consisting of side-by-side and one above the other.

4. The method of claim 1, further comprising:
adjusting the size of at least one of either the original image or the modified image such that the combined image is square or rectangular in shape.

5. The method of claim 4 where adjusting the size is done using a method selected from the group consisting of cropping, resealing, and padding.

6. The method of claim 1 where the single image is stored into an image file type selected from the group consisting of Portable Document Format (PDF), Tagged Image File Format (TIFF or TIF), a binary image format (BIN), Windows Bitmap (BMP), Joint Photographic Experts Group (JPEG or JPG).

7. The method of claim 1, wherein the selection of at least one of either the original image or the modified image is automated.

8. A method for storing an original image and a plurality of modified images into a single file, the method comprising:
selecting the original image;
selecting the plurality of modified images;
combining the original image with the plurality of modified images into a single image; and
storing the single image into a single image file on a memory device.

9. The method of claim 8, wherein the selection of the plurality of modified images is automated.

10. A software tool, operating in a processor system, for storing an original image and a modified image into a single file, comprising:
a first user interface device that prompts a user to select the original image and the modified image;
a display area showing the original image and the modified image aligned with respect to each other;
a second user interface device that, when activated, combines the original image with the modified image into a single image and stores the single image into a single image file on a memory device.

11. The software tool of claim 10, wherein an orientation between the original image and the modified image is selected.

12. The software tool of claim 11, wherein the orientation can be selected from the group consisting of side-by-side, and one above the other.

13. The software tool of claim 10, wherein the combined image is adjusted to be square or rectangular in shape by adjusting the size of at least one of either the original image or the modified image.

14. The software tool of claim 13 where adjusting the size is done using a method selected from the group consisting of cropping, resealing, and padding.

15. The software tool of claim 10 wherein the single image is stored into an image file type selected from the group consisting of Portable Document Format (PDF), Tagged Image File Format (TIFF or TIF), a binary image format (BIN), Windows Bitmap (BMP), Joint Photographic Experts Group (JPEG or JPG).

16. The software tool of claim 10, further comprising:
a third user interface device used to activate the software tool, wherein the third user interface device is selected from the group consisting of an icon and a menu item.

17. The software tool of claim 10, wherein the selection of at least one of either the original image or the modified image is automated.

18. A software tool for storing an original image and a modified image into a single file, comprising:
means for prompting a user to select the original image and the modified image;
means for showing the original image and the modified image next to each other;
means for combining the original image with the modified image into a single image and storing the single image into a single image file on a memory device.
